(19) United States
(12) Patent Application Publication
(10) Pub. No.: US 2008/0103046 A1
(43) Pub. Date: May 1, 2008

(54) Process for making a plant growth regulator

(76) Inventors: Francine Palmer, Hoschton, GA (US); James Ellis, Warwick (GB); James Horn, Freehold, NJ (US); Eugene J. Anderson, Marlton, NJ (US); Dwight A. Shamblee, North Charleston, SC (US); Gary Woodward, Northwich (GB)

Correspondence Address: KENVIN E. MC VEIGH;RHODIA INC., CN 7500, 8 CEDAR BROOK DRIVE, CRANBURY, NJ, 08512, US

(21) Appl. No.: 11/895,543

(22) Filed: Aug. 24, 2007

Related U.S. Application Data
(60) Provisional application No. 60/839,996, filed on Aug. 24, 2006.

(51) Int. Cl. A01N 57/20; A01P 21/00; C07F 9/38

(52) U.S. Cl. 504/127; 568/16

(57) ABSTRACT

A method for making a plant growth regulator includes the step of reacting vinyl chloride with a phosphorous reagent.

### FIELD OF THE INVENTION

This invention relates to a process for making plant growth regulator.

### BACKGROUND OF THE INVENTION

Ethephon (2-chloroethyl phosphonic acid, CAS No. 16672-87-0) is a plant growth regulator that is useful as a general use pesticide and in the acceleration of the ripening of fruits and vegetables. Ethephon is applied to various plant growth sites and acts via liberation of ethylene, which is absorbed by the plant and interferes in the growth process, to regulate phases of plant growth and development. Its use varies with plant species, chemical concentration, and time of application. Ethephon is currently registered in the U.S. for use in connection a number of crops, such as, for example, apples, barley, blackberries, cantaloupes, cherries, coffee, cotton, cucumbers, grapes, guava, ornamentals, rye, squash, sugarcane, tobacco, tomatoes, walnuts, and wheat. Ethephon is commercially available in the form of ready-to-use, emulsifiable concentrate and aqueous solution formulations.

Ethephon has typically been made via reaction of phosphorous trichloride with ethylene oxide. This route has disadvantages with respect to low molecular efficiency, the generation of a relatively large volume of undesired by-products such as dichloroethane, and associated elevated production costs and with respect to the need to handle phosphorous trichloride, which is a toxic and corrosive material.

What is needed in the art is a more convenient and/or lower cost route to ethephon.

### SUMMARY OF THE INVENTION

In a first aspect, the present invention is directed to a method for making a plant growth regulator composition, comprising reacting vinyl chloride with a phosphorous reagent.

In a second aspect, the present invention is directed to a plant growth regulator composition, comprising, based on 100 parts by weight (“pbw”) of the composition,
(a) greater than or equal to about 50 pbw 2-chloroethyl phosphonic acid, and
(b) a non-zero amount of less than or equal to about 20 pbw 1-chloroethylphosphonic acid.

### DETAILED DESCRIPTION OF INVENTION AND PREFERRED EMBODIMENTS

As used herein, the terminology “(Cₓ-C_{y})” in reference to an organic group, wherein x and y are each integers, indicates that the group may contain from x carbon atoms to y carbon atoms per group.

As used herein, the term “alkyl” means a monovalent saturated straight chain or branched hydrocarbon group, typically a monovalent saturated (C₁-C₆) hydrocarbon group, such as for example, methyl, ethyl, n-propyl, iso-propyl, n-butyl, sec-butyl, t-butyl, pentyl, or n-hexyl.

As used herein, the term “alkoxyl” means an oxy group that is substituted with an alkyl group, typically a (C₁-C₆)alkyl group, such as for example, methoxyl, ethoxyl, propoxyl, isopropoxyl, butoxyl, pentyloxyl, or hexyloxyl.

As used herein, the term “aryl” means an unsaturated hydrocarbon group that contains one or more six-membered carbon rings in which the unsaturation may be represented by three conjugated carbon-carbon double bonds, wherein one or more of the ring carbons may be substituted with one or more hydroxy, alkyl, alkenyl, alkoxy, halo, or alkylhalo substituents, such as, for example, phenyl, methylphenyl, trimethylphenyl, nonylphenyl, chlorophenyl, trichloromethylphenyl, naphthyl, and anthryl.

As used herein, the term “aralkyl” means an alkyl group substituted with one or more aryl groups, more typically a (C₁-C₆)alkyl substituted with one or more aryl substituents, such as, for example, phenylmethyl, phenylethyl, and triphenylmethyl.

As used herein, the term “organosilyl” means a monovalent substituent group that comprises a silicon atom that is substituted with one or more organic groups, such as for example, methylsilyl, dimethylsilyl, trimethylsilyl, triethylsilyl, tripropylsilyl, trimethoxysilyl, triphenylsilyl, and triphenylmethylsilyl.

As used herein, the term “regioisomers” refers to compounds that have the same molecular formula but differ in molecular structure, that is, wherein the atoms of the molecules of the respective compounds are connected in a different manner.

The desired product of the method of the present invention is the active plant growth regulator compound 2-chloroethyl phosphonic acid, that is, the compound according to structure (II-a):

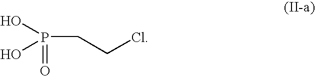

In one embodiment, the plant growth regulator composition of the present invention comprises, based on 100 pbw of the composition, greater than or equal to about 55 pbw, more typically greater than or equal to about 60 pbw, and even more typically greater than or equal to about 65 pbw, 2-chloroethyl phosphonic acid.

In one embodiment, the method of the present invention also produces a regioisomer, 1-chloroethyl phosphonic acid, of 2-chloroethyl phosphonic acid, that is, the compound according to structure (II-b):

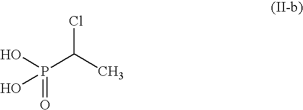

In one embodiment, the plant growth regulator composition of the present invention typically comprises, based on 100 pbw of the composition, less than or equal to about 15 pbw, more typically less than or equal to about 10 pbw, of the 1-chloroethyl phosphonic acid regioisomer.

In one embodiment, the phosphorous reagent is selected from phosphorous acid, monoalkyl-substituted hydrogen phosphites, dialkyl-substituted hydrogen phosphites, mono-organosilyl-substituted hydrogen phosphites, di-organosilyl-substituted hydrogen phosphites, and mixtures thereof.

In one embodiment, the phosphorous reagent comprises one or more compounds according to structure (I): 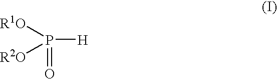
wherein
R¹ and R² are each independently H, alkyl, or —Si(R³)₃, and
each R³ is independently alkyl, alkoxyl, aryl, or aralkyl.

In one embodiment, the phosphorous reagent comprises:
(I-a) a compound according to structure (I) wherein R¹ and R² are each H, or
(I-b) one or more compounds according to structure (I), wherein R¹ is alkyl, more typically (C₁-C₆)alkyl, even more typically (C₁-C₄)alkyl, and R² is H, or
(I-c) one or more compounds according to structure (I) wherein R¹ and R² are each alkyl, more typically (C₁-C₆)alkyl, even more typically (C₁-C₄)alkyl, or
(I-d) a mixture comprising two or more compounds selected from (I-a), (I-b), and (I-c).

In one embodiment, the phosphorous reagent comprises:
(I-e) one or more compounds according to structure (I), wherein R¹ is —Si(R³)₃ and R² is H, or
(I-f) one or more compounds according to structure (I), wherein R¹ and R² are each —Si(R³)₃, or
(I-g) a mixture comprising two or more compounds selected from (I-a), (I-e), and (I-f).

In one embodiment R³ is (C₁-C₆)alkyl, more typically (C₁-C₄)alkyl, and even more typically, methyl.

In one embodiment, the phosphorous reagent comprises one or more compounds selected from monomethyl hydrogen phosphite, monoethyl hydrogen phosphite, monopropyl hydrogen phosphite, monobutyl hydrogen phosphite, mono (trimethylsilyl)hydrogen phosphite, mono (triethylsilyl)hydrogen phosphite, mono (tripropylsilyl)hydrogen phosphite, dimethyl hydrogen phosphite, diethyl hydrogen phosphite, dipropyl hydrogen phosphite, dibutyl hydrogen phosphite, di(trimethylsilyl) hydrogen phosphite, di(triethylsilyl)hydrogen phosphite, di(tripropylsilyl) hydrogen phosphite, and phosphorous acid, di(trimethylsilyl)hydrogen phosphite, di(triethylsilyl)hydrogen phosphite, di(tripropylsilyl)hydrogen phosphite.

Suitable phosphorous reagents are commercially available or can be made by known methods.

In one embodiment, the phosphorous reagent comprises a monoalkyl hydrogen phosphite, a dialkyl hydrogen phosphite, or is a mixture comprising a monoalkyl hydrogen phosphite and a dialkyl hydrogen phosphite, more typically, a mixture comprising a monoalkyl hydrogen phosphite, a dialkyl hydrogen phosphite, and phosphorous acid. A typical phosphorous reagent according to this embodiment is made, for example, by direct esterification or trans-esterification of phosphorous acid or by reaction of a dialkyl hydrogen phosphite with phosphorous acid. Typically, the esterification reaction is conducted, optionally in a solvent such as xylene, under reflux conditions to remove water as it is generated during the reaction. The relative amounts of the components of the product mixture can be varied by varying the relative amount of reactants and/or varying the reaction conditions.

In one embodiment, the phosphorous reagent is a mixture of monomethyl hydrogen phosphite, dimethyl hydrogen phosphite, and phosphorous acid. A typical phosphorous reagent according to this embodiment is made, for example, by reacting dimethyl hydrogen phosphite and phosphorous acid in situ or by heating a mixture of dimethyl hydrogen phosphite and phosphorous acid to 120° C.-140° C. for 1 hour under a nitrogen atmosphere. In one embodiment, the phosphorous reagent is made by reacting equimolar amounts of dimethyl hydrogen phosphite and phosphorous acid.

In one embodiment, the phosphorous reagent is a mixture of monobutyl hydrogen phosphite, dibutyl hydrogen phosphite, and phosphorous acid. A typical phosphorous reagent according to this embodiment is made, for example, by direct esterification of phosphorous acid with butanol.

In one embodiment, the phosphorous reagent comprises a mono-trialkylsilyl hydrogen phosphite, a di-trialkylsilyl hydrogen phosphite or a mixture thereof, more typically a mixture of mono-trialkylsilyl hydrogen phosphite, di-trialkylsilyl hydrogen phosphite, and phosphorous acid. A typical phosphorous reagent according to this embodiment is made, for example, by reacting phosphorous acid and a hexaalkyldisiloxane, such as hexamethyldisiloxane.

The reaction of vinyl chloride with the phosphorous reagent is carried out in the presence of a free radical initiator to produce a chloroethyl-substituted phosphorous compound.

In one embodiment, the reaction of vinyl chloride with the phosphorous reagent (I) is carried out according to Scheme (A): 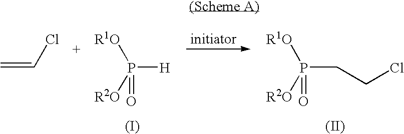
wherein R¹ and R² are each as defined above, to form a chloroethyl-substituted phosphorous compound (II).

In one embodiment, the reaction of vinyl chloride with the phosphorous reagent is conducted using at least substantially equimolar amounts of vinyl chloride and the phosphorous reagent, wherein “substantially equimolar” means that the amounts of vinyl chloride and the phosphorous reagent are equimolar within a tolerance of plus or minus about 5%.

In one embodiment, the reaction is conducted using an excess of up to about 5 mole percent (“mol %”) vinyl chloride.

Suitable initiators include initiator compounds such as, for example, organic peroxides, inorganic peroxides, and azo initiators, which generate free radicals upon decomposition. Alternatively, the initiator may be an energy source, such as ionizing radiation, including, for example, X-rays, gamma-rays, and ultraviolet light. In another embodiment, the initiator is system that combines an initiator compound and an energy source, such as peroxide-ultraviolet light initiator systems and azo-ultraviolet light initiator systems, wherein the reaction is initiated by subjecting an initiator compound to radiation that causes decomposition of the initiator compound to thereby generate free radicals. Initiator compounds may be used in combination with photosensitizers or with compounds, such as transition metals or transition metal complexes, that catalyze decomposition of the initiator compound to generate free radicals.

Suitable initiator compounds typically have a half life of less than or equal to about 10 hours within the intended temperature range for the reaction, typically of from about 2 to about 10 hours at a temperature of from about 80° C. to about 150° C., and more typically of from about 4 to about 8 hours at a temperature of from about 80° C. to about 150° C. In one embodiment, the reaction of vinyl chloride with the phosphorous reagent is initiated by an initiator compound selected from aryl peroxides, such as benzoyl peroxide, dialkyl peroxides, such as di-tert-butyl peroxide, and inorganic peroxides, such as a persulfate, a perphosphate, or hydrogen peroxide, and mixtures thereof.

Typically, the amount of initiator compound ranges from about 0.5 to about 10 mol %, more preferably from about 1 to about 5 mol % initiator compound, based on the amount of vinyl chloride reactant. The initiator compound may be added to the reaction mixture in any convenient way, such as for example, by adding a single charge of initiator compound at the beginning of the reaction, by adding two or more discrete portions of initiator compound to the reaction mixture periodically during the reaction, or by adding a stream of initiator compound to the reaction mixture continuously during the reaction.

In one embodiment, the reaction of vinyl chloride with the phosphorous reagent is conducted without any added solvent. In one alternative embodiment, the reaction of vinyl chloride with the phosphorous reagent is conducted is conducted in a 2-chloroethyl phosphonic acid medium, more typically in from about 4 to about 40 pbw 2-chloroethyl phosphonic acid per pbw of phosphorous reagent. In another alternative embodiment, the reaction mixture further comprises up to about to about 95 pbw, more typically up to about 85 pbw, of a polar organic solvent per pbw phosphorous reagent. Suitable polar organic solvent are those, such as, for example, dioxane, acetic acid, and lower alkanols, such as butanol, as well as mixtures of such solvents.

In general, the reaction of vinyl chloride with the phosphorous reagent is conducted under relatively mild conditions. In a preferred embodiment, the reaction is conducted at a temperature of from about 90° C. to about 170° C., more preferably from about 100° C. to about 140° C. Conducting the reaction at a temperature toward the higher end of the reaction temperature range tends to reduce production of 1-chloroethyl phosphonic acid and/or alkyl or organosilyl substituted 1-chloroethyl phosphonic acid precursors.

In one embodiment, the reaction of vinyl chloride with the phosphorous reagent is conducted under an inert atmosphere, such as, for example, under an argon or nitrogen atmosphere.

In general, the reaction of vinyl chloride with the phosphorous reagent is conducted at a pressure of about atmospheric pressure or greater. In one embodiment, the reaction is conducted at pressure of from about atmospheric pressure to about 100 pounds per square inch gauge (“psig”), more typically from about 20 to about 80 psig. Working above atmospheric pressure tends to reduce production of 1-chloroethyl phosphonic acid and/or alkyl or organosilyl substituted 1-chloroethyl phosphonic acid precursors.

In those embodiments in which the phosphorous reagent comprises a compound according to structure (I-a): 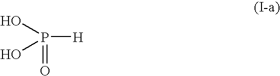
the chloroethyl-substituted phosphorous compound (II) produced by the reaction of vinyl chloride according to Scheme (A) is the desired 2-chloroethyl phosphonic acid product (II-a), as illustrated in Scheme (A-1):

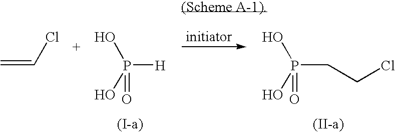

In those embodiments in which the phosphorous reagent comprises one or more alkyl- or organosilyl-substituted phosphite compounds, the chloroethyl-substituted phosphorous compounds produced by the reaction with vinyl chloride is an intermediate that comprises one or two alkyl or organosilyl substituents. The alkyl or organosilyl substituents are then removed to produce the desired 2-chloroethyl phosphonic acid product In a directly analogous manner, removal of alkyl or organosilyl substituents from any alkyl or organosilyl substituted 1-chloroethyl phosphonic acid precursors produces the 1-chloroethyl phosphonic acid regioisomer of the desired 2-chloroethyl phosphonic acid product.

In one embodiment, the alkyl substituents of an alkyl-substituted chloroethyl phosphorous intermediate are removed by reacting the intermediate with acid, with water, or with a mixture of acid and water, under conditions effective to form the desired 2-chloroethyl phosphonic acid product.

In those embodiments in which the phosphorous reagent comprises one or more monoalkyl-substituted compounds according to structure (I-b): 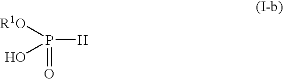
wherein R¹ is alkyl, the reaction with vinyl chloride according to Scheme (A) forms one or more corresponding monoalkyl-substituted chloroethyl-substituted phosphorous intermediates (II-b): 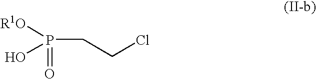
wherein R¹ is alkyl.

In one embodiment, dealkylation of any monoalkyl-substituted chloroethyl phosphorous intermediate (II-b) is conducted according to Scheme (B-1) and/or (B-2): 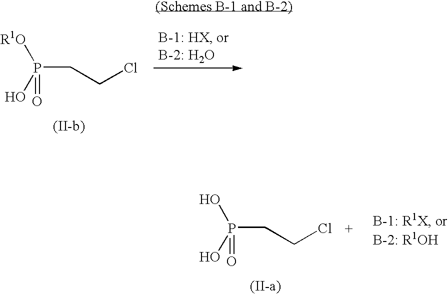
wherein R¹ is alkyl and HX is an acid, by contacting compound (II-b) with water and/or acid under conditions appropriate to form the desired 2-chloroethyl phosphonic acid product (II-a) and an acid and/or alcohol by-product.

In those embodiments in which the phosphorous reagent comprises one or more compounds according to structure (I-c): 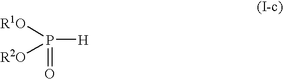
wherein R¹ and R² are each independently alkyl, reaction with vinyl chloride according to Scheme (A) forms one or more corresponding dialkyl-substituted chloroethyl-substituted phosphorous intermediates (II-c): 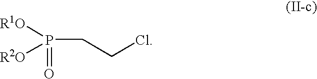
wherein R¹ and R² are each independently alkyl.

In one embodiment, dealkylation of a dialkyl-substituted chloroethyl phosphorous intermediate (II-c) is conducted according to Scheme (B-3) and/or (B-4): 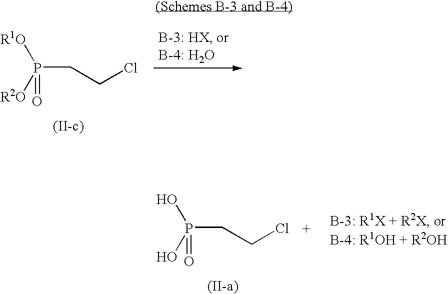
wherein R¹ and R² are each independently alkyl and HX is an acid, by contacting compound (II-c) with water and/or acid under conditions appropriate to form the desired 2-chloroethyl phosphonic acid product (II-a) and an acid and/or alcohol by-product.

In one embodiment, dealkylation of a mixture containing monoalkyl-substituted chloroethyl phosphorous intermediate (II-b) and dialkyl-substituted chloroethyl phosphorous intermediate (II-c) is conducted according to Schemes (B-1), (B-2) (B-3), and/or (B-4), by contacting the mixture of compounds (II-b) and (II-c), which mixture may, optionally, further comprise phosphorous acid, with acid and/or water under conditions appropriate to form the desired 2-chloroethyl phosphonic acid product (II-a) and an acid and/or alcohol by product.

In each case, X is typically halo, even more typically chloro.

The acid used in the dealkylation step may be any strong acid, for example, an acid having a pKₐ in water of less than or equal to about 5. Any suitable acid may be used for hydrolysis, in catalytic to stoichiometric amounts with or without water or other proton source such an alcohol. Non limiting examples of suitable strong acids are hydrohalogen acids (HCl, HBr, HI, HF) or mixtures thereof, mineral acids such as sulphuric, nitric or mixtures thereof, or an organic acid. In one embodiment, the acid is an inorganic acid, more typically a hydrohalogen acid, and even more typically hydrochloric acid.

In general, the dealkylation is conducted using catalytic amount of acid, water, or a mixture of acid and water, based on the amount of alkyl substituents to be dealkylated. In one embodiment, the dealkylation is conducted using from about 0.01 to about 1 molar equivalent, more typically from about 0.6 to about 0.9 molar equivalent, of acid, water, or a mixture of acid and water, per mole of alkyl substituents.

In general, the dealkylation is conducted under relatively mild conditions. In a preferred embodiment, the dealkylation is conducted at a temperature of from about 50° C. to about 180° C., more typically from about 70° C. to about 160° C.

In general, the dealkylation is conducted at a pressure of atmospheric pressure or greater. In one embodiment, the dealkylation is conducted at pressure of from about atmospheric pressure to about 100 psig, more typically from about 20 to about 80 psig.

In one embodiment, the organosilicon substituents of an organosilicon-substituted chloroethyl phosphorous intermediate are removed by hydrolyzing the organosilyl groups to form the desired 2-chloroethyl phosphonic acid product.

In those embodiments in which the phosphorous reagent comprises one or more mono-organosilyl-substituted compounds according to structure (I-e): 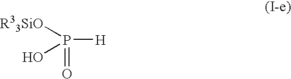
wherein each R³ is independently as described above, the reaction with vinyl chloride according to Scheme (A) forms one or more corresponding mono-organosilyl-substituted chloroethyl-phosphorous intermediates (II-e): 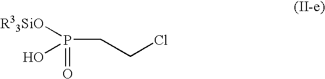
wherein R³ is as described above.

In one embodiment, removal of the organosilyl group from a mono-Si(R³)₃-substituted chloroethyl phosphorous compound (II-e) is conducted according to Scheme (C-1): 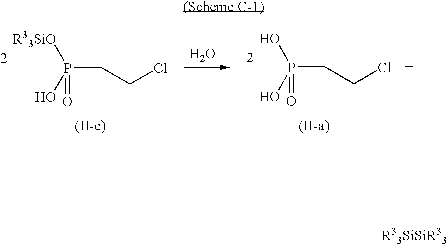
wherein each R³ is independently as described above, by contacting compound (II-e) with water under conditions appropriate to hydrolyze the organosilyl group and form the desired 2-chloroethyl phosphonic acid product (II-a) and a disilane by-product.

In those embodiments in which the phosphorous reagent comprises one or more di-organosilyl-substituted compounds according to structure (I-f): 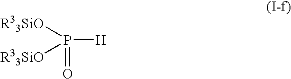
wherein each R³ is independently as described above, the reaction with vinyl chloride forms a corresponding chloroethyl-substituted phosphorous intermediate (II-f) 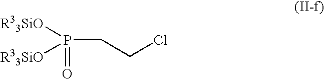
wherein each R³ is independently as described above.

In one embodiment, removal of the organosilyl group from a di-organosilyl-substituted chloroethyl phosphorous compound (II-f) is conducted according to Scheme (C-2): 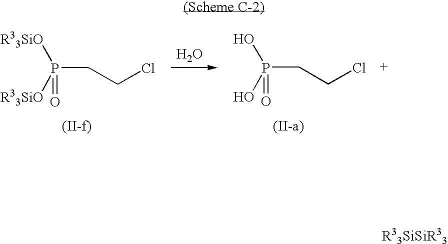
wherein each R³ is independently as described above, by contacting compound (II-f) with water under conditions appropriate to hydrolyze the organosilyl groups and form the desired 2-chloroethyl phosphonic acid product (II-a) and a disilane by-product.

In one embodiment, removal of the organosilyl groups from a mixture of a mono-organosilyl -substituted chloroethyl phosphorous compound (II-e) and a di-organosilyl-substituted chloroethyl phosphorous compound (II-f) is conducted according to Schemes (C-1) and (C-2), by contacting the mixture of compounds (II-e) and (II-f), which mixture may, optionally, further comprise phosphorous acid, with water under conditions appropriate to hydrolyze the organosilyl groups and form the desired product (II-a) and a disilane by-product. For example, organo-groups may be removed by contacting mono-organosilyl-substituted chloroethyl phosphorous compound and/or a di-organosilyl-substituted chloroethyl phosphorous compound with from about 0.01 to about 1 molar equivalent water per mole of organosilyl groups at a temperature of from about 60° C. to about 100° C. The product mixture so formed may then be stripped, for example, by refluxing at about 80° C. to about 100° C. under vacuum, to remove disilane by-product from the product mixture.

### Examples 1A and 1B

The alkyl phosphite mixture of Example 1A was made as follows. To a 500 ml round bottom flask was charged 205.0 g (2.5 moles) of phosphorous acid and 277.95 g (3.75 moles) of 1-butanol. The flask was equipped with a Dean-Stark receiver with water condenser, nitrogen gas inlet, thermocouple for controlling the reaction temperature, and mechanical agitator with glass stir shaft and Teflon half-moon stir paddle. The Dean-Stark receiver was filled with butanol, agitation was set at 400 revolutions per minute (“rpm”) and the reaction temperature was increased to reflux (˜121 to 128° C.) and maintained for a total of 9.5 hours. ³¹P-NMR of the clear, colorless solution showed with the product mixture with composition in molar ratios, phosphorous acid:monobutyl phosphite:dibutyl phosphite of 11:56:33.

The alkyl phosphite mixture of Example 1B was made as follows. To a 250 ml round bottom flask was charged 40.00 g (0.49 moles) of phosphorous acid, 90.39 (1.22 moles) of 1-butanol, and 51.81 g (0.49 moles) of xylenes. The flask was equipped with a Dean-Stark receiver with water condenser, nitrogen gas inlet, thermocouple for controlling the reaction temperature, and mechanical agitator with glass stir shaft and Teflon half-moon stir paddle. The Dean-Stark receiver was filled with butanol, agitation was set at 400 rpm and the reaction temperature was increased to reflux (˜121° C.) and maintained for a total of 4.5 hours. ³¹P-NMR of the clear, colorless solution showed 85 mole % conversion of phosphorous acid to alkyl phosphites, with molar ratios, phosphorous acid monobutyl phosphite:dibutyl phosphite of 15:58:27.

### Example 2

The 2-chloroethyl phosphonic acid of Example 2 was made according to reaction scheme (D): 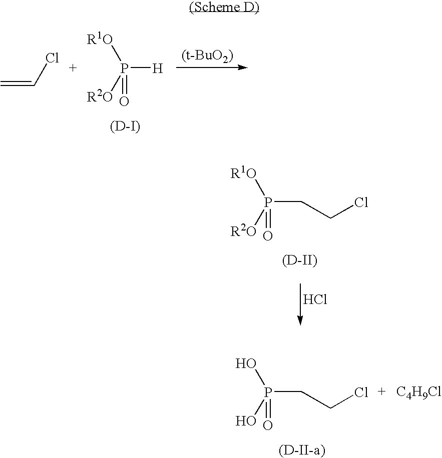
using the phosphorous acid, monobutyl phosphite, and dibutyl phosphite mixture of Example 1A as phosphorous reagent mixture (D-I).

An 800 ml glass reactor, equipped with a turbine agitator, a heating oil bath, a temperature controller, a condenser, and a gas sparger tube, was purged with N₂ gas and then charged with 173.0 g of the phosphorous acid, monobutyl phosphite, and dibutyl phosphite mixture of Example 1A above as phosphorous reagent mixture (D-I). The agitator was set at rapid speed and the temperature controller was set to control the temperature of the reactor contents to within the range of 125-130° C. After the temperature of the reactor contents reached the set range, charging to the reactor of 3.7 g (0.0251 mole) di-tert-butyl peroxide and 78.3 g (1.3 moles) vinyl chloride was begun. 10% of the total charge of di-tert-butyl peroxide as added in one shot at the beginning of the reaction period and the remainder was charged to the reactor over the remainder of the reaction period at a constant incremental rate. The vinyl chloride was charged to the reactor, below the surface of the reaction mixture, over the reaction period at a constant incremental rate. The temperature of the reaction mixture was maintained within the range of 125-130° C. over the reaction period. The reaction was run for a total of about 14 hours of reaction time (the “reaction period”), conducted in two parts of about 7 hours each, with overnight cooling to ambient temperature between the two parts of the reaction period. The reaction mixture was sampled every 2-4 hours during the reaction period and monitored by ³¹P NMR. At the end of the reaction period, the heat source was removed and the peroxide and vinyl chloride flows were discontinued. The chloroethyl phosphonic acid intermediate mixture (D-II) was allowed to cool to below about T_{R} below 45° C. and discharged from the reactor.

An 500 ml glass reactor, equipped with an magnetic stirrer, a heating mantle, and a temperature controller was charged with 190 g of the chloroethyl phosphonic acid intermediate mixture (D-II) from the above described free radical addition reaction step of reaction scheme D. The stirrer was set at rapid speed and the temperature controller set to maintain the temperature of the reactor contents at 120-125° C. 80 g concentrated HCl was charged to the reactor. The reactor was sealed and the pressure within the reactor was allowed to increase as the temperature of reactor contents increased. The reaction was run for about 2 hours. ³¹P NMR indicated about 80% conversion of the intermediate mixture (D-II) to a product mixture comprising the desired 2-chloroethyl phosphonic acid product (D-II-a)).

1. A method for making a plant growth regulator composition, comprising reacting vinyl chloride with a phosphorous reagent.

2. The method of claim 1, wherein the phosphorous reagent comprises one or more compounds according to structure (I): 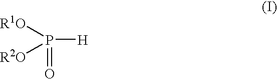
wherein
R¹ and R² are each independently H, alkyl, or —Si(R³)₃, and
each R³ is independently alkyl, alkoxyl, aryl, or aralkyl.

3. The method of claim 2, wherein the phosphorous reagent comprises:
(I-a) a compound according to structure (I) wherein R¹ and R² are each H, or
(I-b) one or more compounds according to structure (I), wherein R¹ is alkyl and R² is H, or
(I-c) one or more compounds according to structure (I) wherein R¹ and R² are each alkyl, or
(I-d) a mixture comprising two or more compounds selected from (I-a), (I-b), and (I-c), or
(I-e) one or more compounds according to structure (I), wherein R¹ is —Si(R³)₃ and R² is H, or
(I-f) one or more compounds according to structure (I), wherein R¹ and R² are each —Si(R³)₃, or
(I-g) a mixture comprising two or more compounds selected from (I-a), (I-e), and (I-f).

5. The method of claim 1, wherein the reaction of vinyl chloride with the phosphorous reagent is carried out in the presence of a free radical initiator to form a chloroethyl-substituted phosphorous compound.

6. The method of claim 5, wherein the free radical initiator is a free radical initiator compound having a half life of from about 2 to about 10 hours at a temperature of from about 80° C. to about 150° C.

7. The method of claim 5, wherein the reaction of vinyl chloride with the phosphorous reagent is carried out in a 2-chloroethyl phosphonic acid medium.

8. The method of claim 5, wherein the reaction of vinyl chloride with the phosphorous reagent is carried out in a polar organic solvent.

9. The method of claim 5, wherein the reaction of vinyl chloride with the phosphorous reagent is carried out in at a temperature of from about 90° C. to about 170° C.

10. The method of claim 5, wherein the reaction of vinyl chloride with the phosphorous reagent is carried out in under an inert atmosphere.

11. The method of claim 5, wherein the reaction of vinyl chloride with the phosphorous reagent is carried out in at a pressure of about atmospheric pressure or greater.

12. The method of claim 5, wherein the phosphorous reagent comprises phosphorous acid and the chloroethyl-substituted phosphorous compound formed by the reaction of vinyl chloride with the phosphorous reagent comprises 2-chloroethyl phosphonic acid.

13. The method of claim 5, wherein the reaction of vinyl chloride with the phosphorous reagent forms an alkyl-substituted intermediate, comprising a monoalkyl-substituted chloroethyl phosphorous intermediate, a dialkyl-substituted chloroethyl phosphorous intermediate, or mixture of a alkyl-substituted chloroethyl phosphorous intermediate and a dialkyl-substituted chloroethyl phosphorous intermediate, and wherein the alkyl-substituted intermediate is dealkylated is by contacting the alkyl-substituted intermediate with acid, with water, or with a mixture of water and acid, under conditions effective to produce 2-chloroethyl phosphonic acid.

14. The method of claim 13, wherein the alkyl-substituted intermediate is dealkylated by contacting the intermediate with an acid having a pKₐ in water of less than or equal to about 5.

15. The method of claim 13, wherein the dealkylation is conducted using from about 0.01 to about 1 molar equivalent of acid, water, or a mixture of acid and water, per mole of alkyl substituents.

16. The method of claim 13, wherein the dealkylation is conducted at a temperature of from about 50° C. to about 180° C.

17. The method of claim 13, wherein the dealkylation is conducted at a pressure of atmospheric pressure or greater.

18. The method of claim 5, wherein the reaction of vinyl chloride with the phosphorous reagent forms an organosilyl-substituted intermediate, comprising a mono-organosilyl-substituted chloroethyl phosphorous intermediate, a di-organosilyl-substituted chloroethyl phosphorous intermediate, or a mixture mono-organosilyl-substituted chloroethyl phosphorous intermediate and di-organosilyl-substituted chloroethyl phosphorous intermediate, and wherein the organosilyl groups of the organosilyl-substituted intermediate are removed by contacting the organosilyl-substituted intermediate with water under conditions appropriate to hydrolyze the organosilyl groups and form 2-chloroethyl phosphonic acid.

19. The method of claim 18, wherein the organosilyl-substituted intermediate is contacted with from about 0.01 to about 1 molar equivalent water per mole organosilyl groups.

20. The method of claim 18, wherein the organosilyl-substituted intermediate is contacted with water at a temperature of from about 60° C. to about 100° C.

21. The method of claim 18, wherein contacting the organosilyl-substituted intermediate is contacted with water under conditions appropriate to form 2-chloroethyl phosphonic acid forms a product mixture comprising 2-chloroethyl phosphonic acid and a silane by-product, and wherein the method comprises stripping the product mixture to remove the silane by-product.

22. A plant growth regulator composition made by the method of claim 1.

23. A plant growth regulator composition, comprising, based on 100 parts by weight of the composition:
(a) greater than or equal to about 50 parts by weight 2-chloroethyl phosphonic acid, and
(b) a non-zero amount of less than or equal to about 20 parts by weight of 1-chloroethylphosphonic acid.
